(19) United States
(12) Patent Application Publication
(10) Pub. No.: US 2008/0289079 A1
(43) Pub. Date: Nov. 27, 2008

(54) GARMENT FOR USE IN A BREAST SELF-EXAMINATION

(76) Inventor: Linda P. Lewis, Marietta, GA (US)

Correspondence Address: GEORGE R. REARDON, 3356 STATION COURT, LAWRENCVILLE, GA, 30044, US

(21) Appl. No.: 12/124,141

(22) Filed: May 20, 2008

Related U.S. Application Data
(60) Provisional application No. 60/939,590, filed on May 22, 2007.

(51) Int. Cl. A41B 9/00; G09B 23/28

(52) U.S. Cl. 2/114; 434/262

(57) ABSTRACT

The technology described herein provides a garment, system and method for facilitating a wearer to conduct a breast self exam by following a raised, patterned diagram with the fingers, feeling for lumps in the breast tissue, and denoting areas of concern on the garment at the location where area of concern are noticed.

### CROSS-REFERENCE TO RELATED APPLICATION(S)

The present non-provisional patent application claims the benefit of priority of U.S. Provisional Patent Application No. 60/939,590, which is entitled “A KNITTED GARMENT INCLUDING A DIRECTIONAL DIAGRAM TO AID IN PERFORMING A BREAST SELF-EXAM”, which was filed on May 22, 2007, and which is incorporated in full by reference herein.

### COPYRIGHT NOTICE

Copyright© 2007 The Breast Chek Kit, Inc. A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The technology described herein relates generally to the field of devices for detecting breast abnormalities, and specifically relates to a device, system and method which facilitate breast self-examination according to medical industry specifications.

### BACKGROUND OF THE INVENTION

Breast cancer is among the most common malignant tumors and is the leading cause of death from cancer among women in the United States. The primary methods of breast cancer detection are mammography and physical examination. Research indicates that the earlier the cancer is discovered, the smaller the tumor is, as a result of which the chances for survival are greater. Thus, early detection of breast cancer reduces the mortality rate resulting from this disease.

Approximately one in nine women in the United States will be diagnosed with breast cancer during their lifetimes. The majority of all incidences of breast cancer is diagnosed by the women themselves and are merely confirmed by physicians. Early diagnosis greatly improves the results of breast cancer treatment and is possible if women are taught to examine their own breasts for the appropriate indicators of breast cancer. However, less than 20% of American women currently practice self-examination on a regular basis.

Breast self-examination (BSE) is a worthwhile, inexpensive method of early breast cancer detection. Between ten and fifteen percent of palpable cancers are not picked up by mammography. Frequent BSE performance is associated with a more favorable clinical stage, meaning that there is a better chance for successful treatment, and fewer auxiliary lymph metastasis, meaning less chance of the cancer spreading to the patient's lymph nodes.

The primary reason that so few women regularly practice BSE is motivation. When taught by a health care provider, a woman can learn a systematic approach to examining her breasts. However, without constant reminders from her physician, a woman lacks the proper motivation to practice BSE year round. Motivation involves a constant reminder to practice BSE and instilling in the patient sufficient confidence to examine her breasts in order to determine whether any changes have occurred since her last self-examination.

Not to be overlooked, however, is the importance of educating patients to practice BSE as a means of overcoming the fears associated with discovering breast cancer. Through BSE, patients are more knowledgeable regarding their breast tissues and, in time, become more and more confident in their ability to determine areas of concern.

Related patents known in the art include U.S. Pat. Nos. 5,207,582, 5,479,661, and 6,817,865, all of which are incorporated herein by reference, which describe devices used to train persons in breast cancer detection.

U.S. Pat. No. 5,207,582 discloses a device for facilitating breast self-examinations in order to speed up detection of breast cancer. The device includes an information panel, preferably manufactured from a waterproof acrylic material. Instructions for conducting self-examinations and diagrams for recording the results thereof are included on the information panel. Recording means, such as a grease pencil, are also included, as is a calendar for tracking the dates of the self-examinations. Alternatively, transparent overlays may be employed for recording the results of each self examination separately and comparing the results of subsequent examinations to one another.

U.S. Pat. No. 5,479,661 discloses an instructional upper body garment wearable by a woman and having printed instructions thereon for self-examination of the breasts for detection of cancer or tumors. The garment includes two rectangular panels affixed at the shoulders, having a central neck opening and open sides. Ties are provided for releasable connection of a portion of the sides of the panels during use. The printed instructions and graphics are positioned upside-down on the front panel so the wearer can read them while wearing the garment. The open sides of the panels allow the woman to access her breasts during the examination, yet the garment also provides sufficient privacy.

U.S. Pat. No. 6,817,865 discloses a training device for breast examination comprises a resilient body composed of a flesh-like material. A plurality of nodules is embedded within the resilient body. A base is attached to a bottom surface of the resilient body. The base is provided with breast self-examination instructions.

There is a need in the art for a device, system and method which serve to motivate women to undertake to regularly conduct systematic self-examinations of their breasts in order to assist in the early detection of breast cancer.

### BRIEF SUMMARY OF THE INVENTION

In various exemplary embodiments, the technology described herein provides a garment having a diagram which is used for performing a breast self examination, made from a seamless circular knitted yarn of varying deniers, to form a breathable, stretchable material, e.g., of nylon and LYCRA SPANDEX, giving the garment elasticity for imparting the selected shape of a user's breast when worn and providing fit and support for various sizes of breasts. The yarn used has wicking capabilities for keeping the body cooler and drier. The garment is seamless, which makes it very stretchable, and facilitates the garment feeling like a second skin. The garment also contains compression yarn so as to fit snug on the breast tissue. The garment is tag-less. The diagram does not force a breast nipple to a particular location, thus allowing for varying breast sizes.

The diagram and the garment are made using a hosiery machine i.e., an electronic circular knitting machine with individual needle selections on a cylinder, e.g., a Santoni knitting machine. The diagram on the garment is knitted into the garment, e.g., in a dotted line up and down pattern which includes knitted semi-circles with an arrow to indicate direction to the user. The diagram is located on the front of the garment on both the left breast area and right breast area, as well as partially under each arm. The garment is preferably made with 92% nylon and 8% SPANDEX. The nylon makes the garment strong, lightweight and is soft to the touch and the SPANDEX allows the garment to expand to accommodate the breast tissue.

The garment can be constructed using different weights of yarn, different types of yarn from different manufacturers. It can be constructed using different types of machinery instead of the Santoni knitting machine.

In an exemplary embodiment the garment comprises a seamless tubular body with a circular knit nylon and LYCRA SPANDEX yarn and a seamless shoulder with adjoining sleeves. An embedded, knitted, up and down series of dashes form a diagram along with semi circles embedded in the breast area of the tubular body and underarm of the sleeve and is used to facilitate a breast self examination by allowing the woman or man to feel and follow the diagram for greater coverage in detecting lumps on the breast and by recording the results directly on the garment with a permanent fabric marker.

The garment is further comprised of a component of elastane in the breast area providing support and flexibility, i.e., the breast area has a yarn of greater denier than the body. The varying deniers of yarn with S and Z twist add balance to the garment. The diagram is comprised of covered deep dye SPANDEX dyes tonally darker than the nylon and is plated to the back of the fabric, which allows for the diagram (pattern) to be visually darker.

When the garment is manufactured on Santoni SM8.8/SM8TOP/SM8TOP1 machines, needles utilized include a 13″ cylinder needle count 1152, a 15″ cylinder needle count 1344, a 17″ cylinder needle count 1536, with an 8 feed set up on all machines. The cylinder needle and garment size relationships are as follows: XS/S (13″), M/L (13″), XL/XXL (15″), XXL/4XL (17″).

The technology described herein provides a tool for women, men, or the visually impaired with various breast sizes an aid in the early detection of any abnormalities in breast tissue.

In addition to the garment having a diagram, a breast self-examination system comprises a marker, an instruction card, a yearly reminder calendar, a packaging insert having a front portion connected to a rear portion and a container for holding all the elements of the system, where the packaging insert is formed to be seen at the front and rear of the container. The breast self-examination system is designed to facilitate and encourage regularly scheduled breast self-examinations.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a perspective view of a breast self-exam garment, according to an embodiment of the technology;

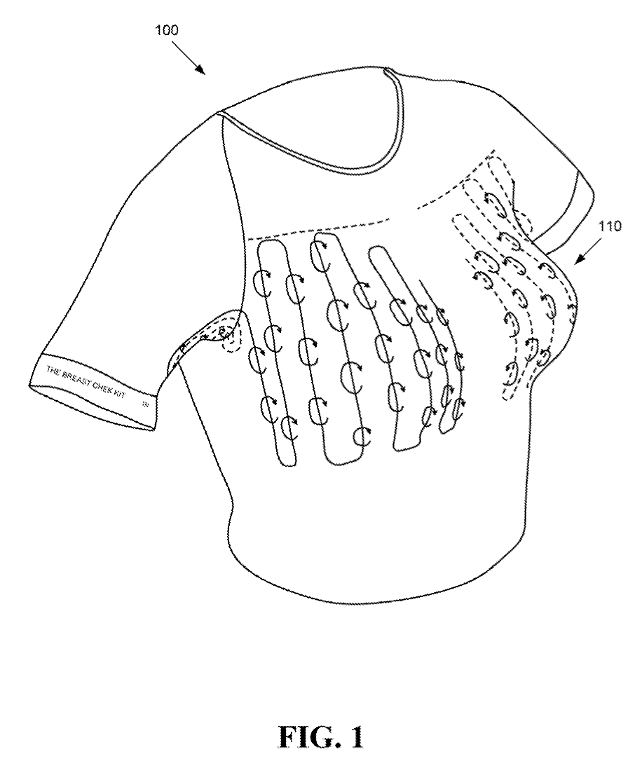

FIG. 2 is a perspective view of a breast self-exam garment, illustrating, in particular, a user conducting a breast self-exam, according to an embodiment of the technology;

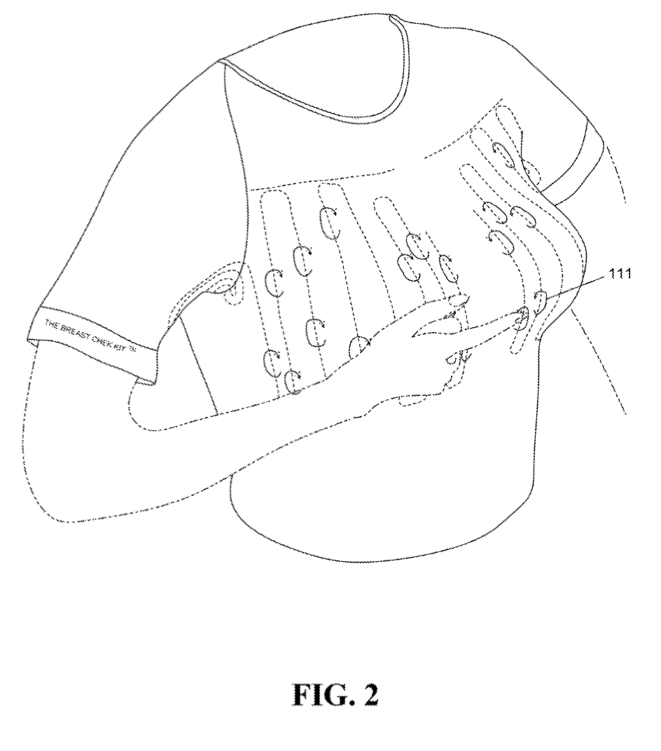

FIG. 3 is a perspective view of a breast self-exam garment, illustrating, in particular, a user denoting an area of concern, according to an embodiment of the technology;

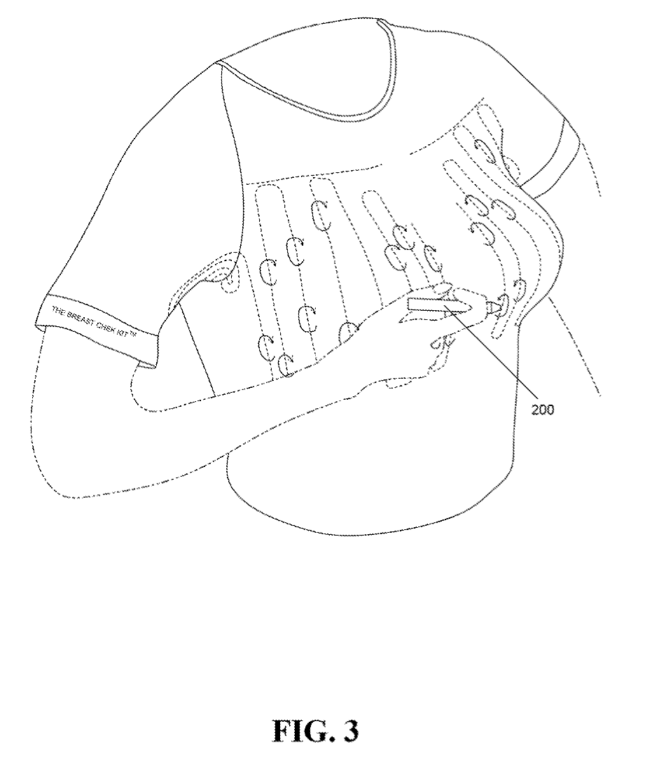

FIG. 4 is a front plan view of a breast self-exam garment, according to an embodiment of the technology;

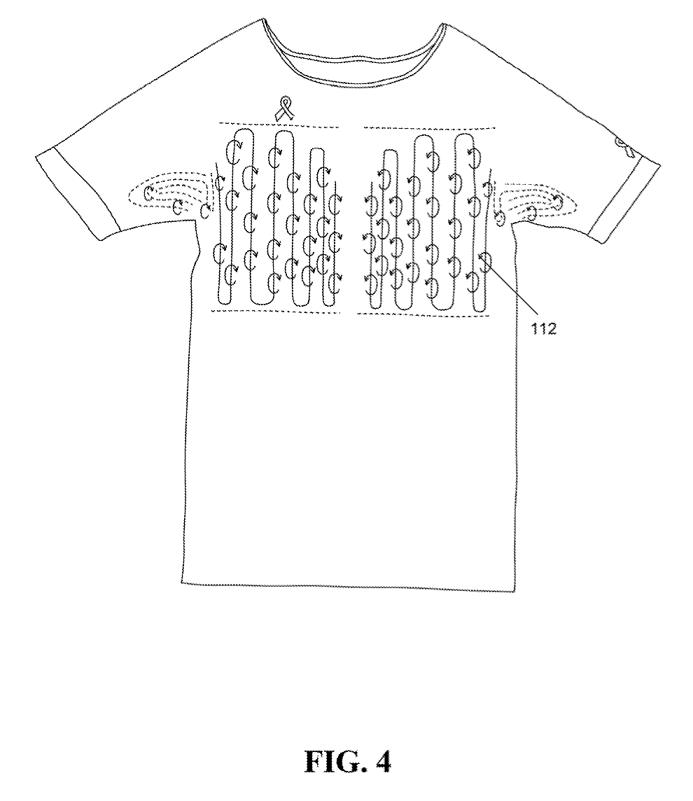

FIG. 5 is a front plan view of a breast self-exam garment, illustrating, in particular, additional examination paths and points for large breasted women, according to an embodiment of the technology;

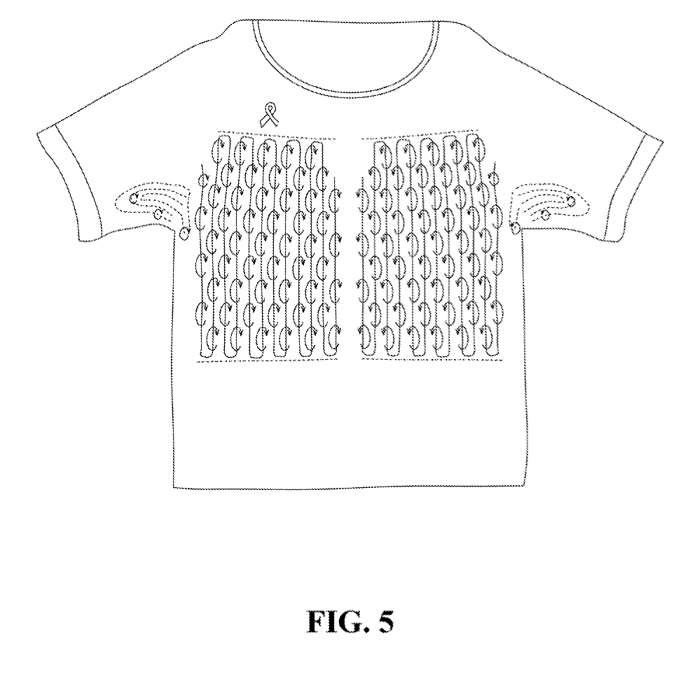

FIG. 6 is a perspective view of a kit container, according to an embodiment of the technology;

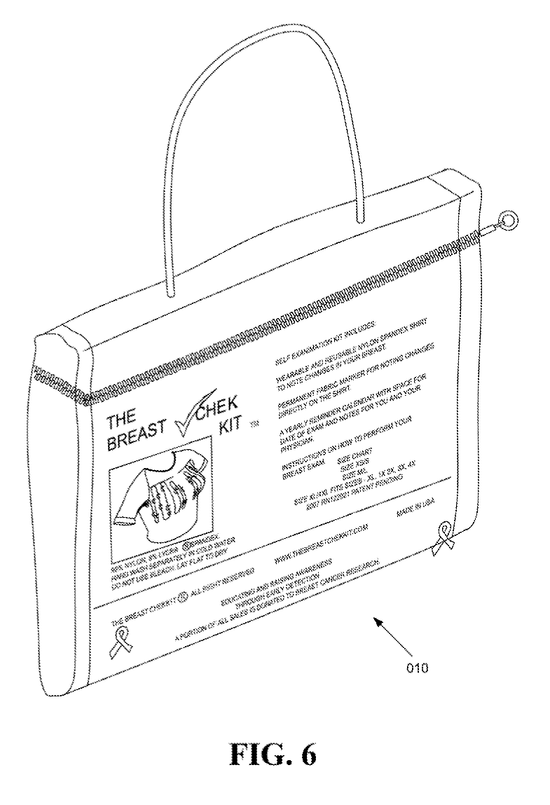

FIG. 7 illustrates components of the kit of FIG. 6, according to an embodiment of the technology;

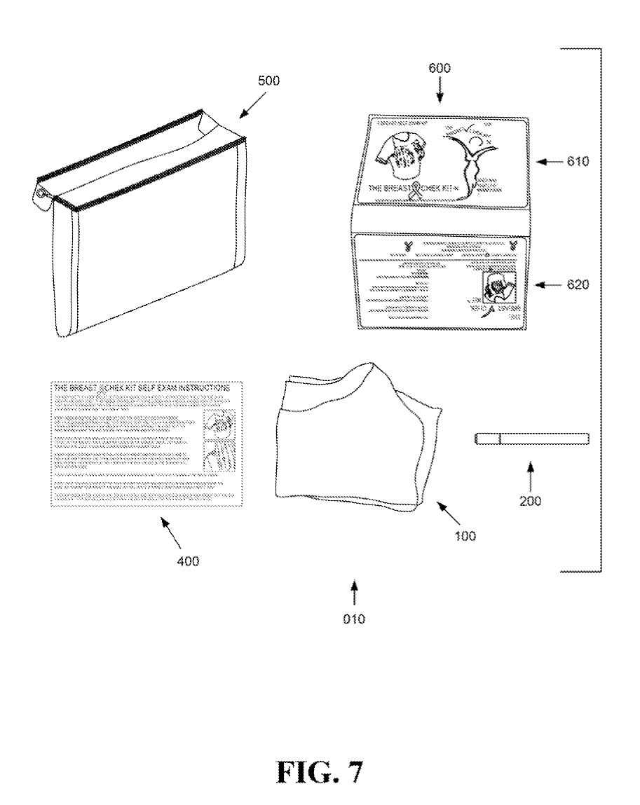

FIG. 8 illustrates one section of an insert for the system of FIG. 6, according to an embodiment of the technology;

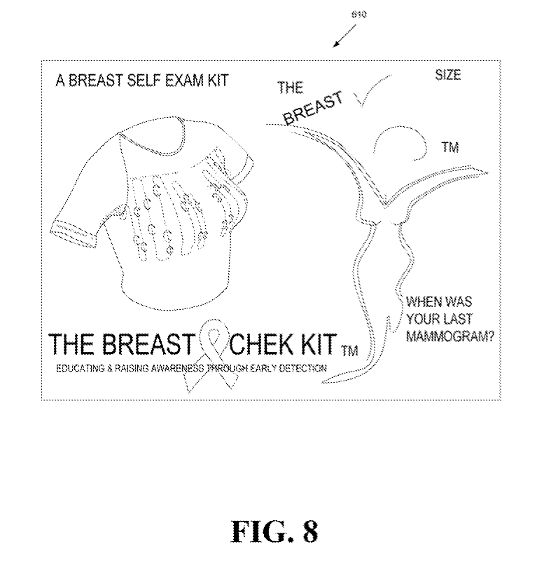

FIG. 9 illustrates a second section of a an insert for the system of FIG. 6, according to an embodiment of the technology;

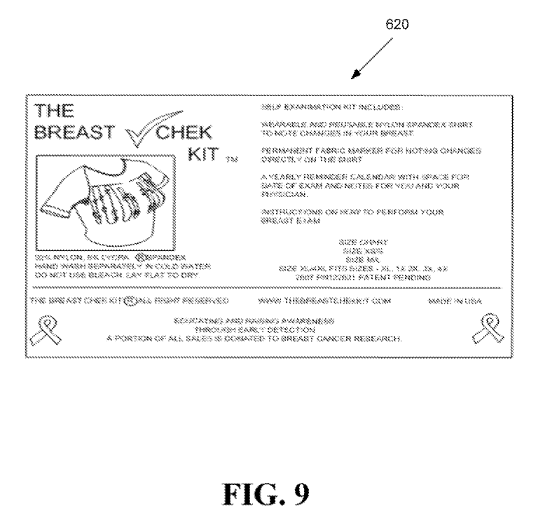

FIG. 10 illustrates an instruction insert for the system of FIG. 6, according to an embodiment of the technology; and

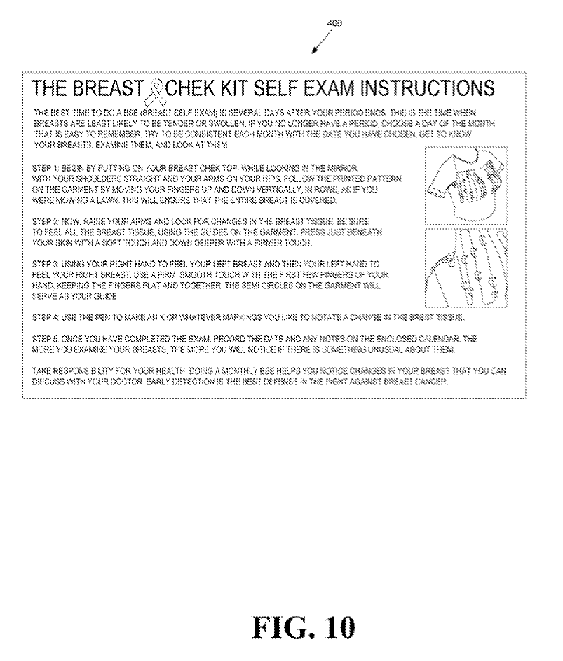

FIG. 11 illustrates a daily calendar for the system of FIG. 6, according to an embodiment of the technology.

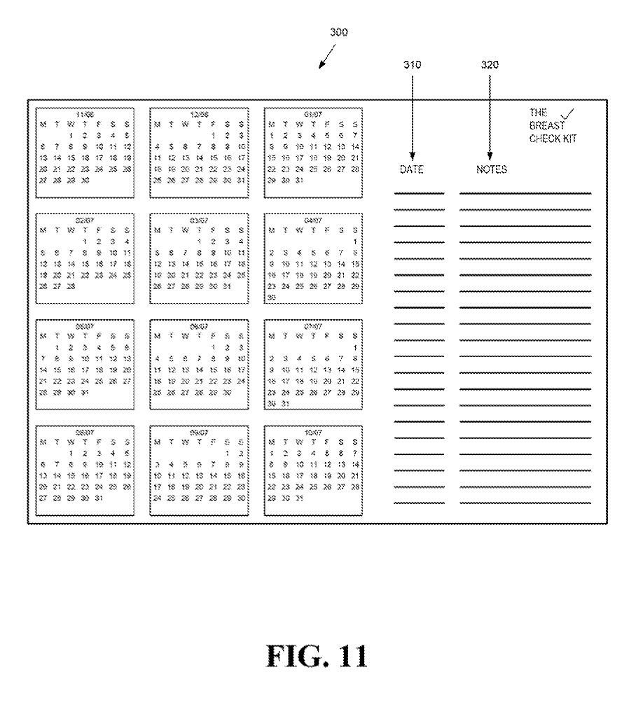

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides an upper body garment 110 for use in a breast self-examination which comprises a directional diagram 110 disposed upon a breast area 120 of the upper body garment 100, the directional diagram 110 configured to aid a wearer in a breast self-examination and to aid the wearer to screen for and detect any abnormalities in a breast tissue.

In one embodiment the upper body garment 110 is comprised of the directional diagram 110 disposed upon the breast area 120 of the upper body garment 100, the directional diagram 110 configured to aid a wearer in a breast self-examination and to aid the wearer to screen for and detect any abnormalities in a breast tissue, where the directional diagram 110 is configured for use by the wearer to follow the directional diagram 110 with a finger pressure in order to feel for lumps and abnormalities within the breast tissue.

In one embodiment the upper body garment 100 is comprised of the directional diagram 110 disposed upon the breast area 120 of the upper body garment 100, the directional diagram 110 configured to aid a wearer in a breast self-examination and to aid the wearer to screen for and detect any abnormalities in a breast tissue, the plurality of semi-circle diagrams 111 is disposed along the directional diagram 110, indicative of a plurality of points where the wearer is to press deeply into a breast tissue in order to feel for lumps and abnormalities within the breast tissue, and each of the plurality of semi-circle diagrams 111 has an arrow 112 to indicate direction.

In one embodiment the upper body garment 100 is comprised of the directional diagram 110 disposed upon the breast area 120 of the upper body garment 100, the directional diagram 110 configured to aid a wearer in a breast self-examination and to aid the wearer to screen for and detect any abnormalities in a breast tissue, where the garment is knitted and is comprised of a plurality of seamless circular knitted yarns of varying deniers to provide elasticity to the wearer and to impart a selected shape of the breasts of the wearer.

In one embodiment the upper body garment 100 is comprised of the directional diagram 110 disposed upon the breast area 120 of the upper body garment 100, the directional diagram 110 configured to aid a wearer in a breast self-examination and to aid the wearer to screen for and detect any abnormalities in a breast tissue, where the directional diagram 110 is knitted into the upper body garment 100.

In one embodiment the upper body garment 100 is comprised of the directional diagram 110 disposed upon the breast area 120 of the upper body garment 100, the directional diagram 110 configured to aid a wearer in a breast self-examination and to aid the wearer to screen for and detect any abnormalities in a breast tissue, where the garment is knitted and is comprised of a plurality of seamless circular knitted yarns of varying deniers to provide elasticity to the wearer and to impart a selected shape of the breasts of the wearer, and where the plurality of semi-circle diagrams 111 is knitted into the garment.

In one embodiment the upper body garment 100 is comprised of the directional diagram 110 disposed upon the breast area 120 of the upper body garment 100, the directional diagram 110 configured to aid a wearer in a breast self-examination and the aid the wearer to screen for and detect any abnormalities in a breast tissue, where the upper body garment 100 is comprised of a first material portion of a nylon material and a second material portion of a SPANDEX material, the nylon material configured to provide strength, lightness, and smoothness to the upper body garment 100, and the SPANDEX material is configured to provide expandability to the upper body garment 100 to accommodate breast tissue.

In one embodiment the upper body garment 100 is comprised of the directional diagram 110 disposed upon the breast area 120 of the upper body garment 100, the directional diagram 110 configured to aid a wearer in a breast self-examination and to aid the wearer to screen for and detect any abnormalities in a breast tissue, where the directional diagram 110 disposed upon the breast area of the upper body garment 100 is configured with a raised surface area, thereby configured to allow a visually impaired wearer to feel and follow the directional diagram 110.

In one embodiment of the technology described herein a breast self-examination system 010 comprises: an upper body garment 100 having a directional diagram 110 disposed upon a breast area of the upper body garment 100, the directional diagram 110 configured to aid a wearer in a breast self-examination and to aid the wearer to screen for and detect any abnormalities in a breast tissue, and a fabric marking indicator 200 for use by the wearer to indicate directly upon the garment any breast tissue changes detected.

In one embodiment of the technology described herein a breast self-examination system 010 comprises: an upper body garment 100 having a directional diagram 110 disposed upon a breast area of the upper body garment 100, the directional diagram 110 configured to aid a wearer in a breast self-examination and to aid the wearer to screen for and detect any abnormalities in a breast tissue; a fabric marking indicator 200 for use by the wearer to indicate directly upon the garment any breast tissue changes detected; and a yearly reminder calendar 300 to facilitate regularly scheduled breast self-examinations, the yearly reminder calendar having a plurality of spaces 310 for dates and a plurality of spaces for notes 320 by the wearer and a physician.

In one embodiment of the technology described herein a breast self-examination system 010 comprises: an upper body garment 100 having a directional diagram 110 disposed upon a breast area of the upper body garment 100, the directional diagram 110 configured to aid a wearer in a breast self-examination and to aid the wearer to screen for and detect any abnormalities in a breast tissue; a fabric marking indicator 200 for use by the wearer to indicate directly upon the garment any breast tissue changes detected; and an instruction sheet 400 with instructions 410 on how to conduct a breast self-examination in the upper body garment 100 for breast self-examination.

In one embodiment of the technology described herein a breast self-examination system 010 comprises: an upper body garment 100 having a directional diagram 110 disposed upon a breast area of the upper body garment 100, the directional diagram 110 configured to aid a wearer in a breast self-examination and to aid the wearer to screen for and detect any abnormalities in a breast tissue; and a fabric marking indicator 200 for use by the wearer to indicate directly upon the garment any breast tissue changes detected, where the directional diagram 110 is configured for use by the wearer to follow the directional diagram 110 with a finger pressure in order to feel for lumps and abnormalities within a breast tissue.

In one embodiment of the technology described herein a breast self-examination system 010 comprises: an upper body garment 100 having a directional diagram 110 disposed upon a breast area of the upper body garment 100, the directional diagram 110 configured to aid a wearer in a breast self-examination and to aid the wearer to screen for and detect any abnormalities in a breast tissue; a fabric marking indicator 200 for use by the wearer to indicate directly upon the garment any breast tissue changes detected; and a plurality of semi-circle diagrams 111 disposed along the directional diagram 110, indicative of a plurality of points where the wearer is to press deeply into the breast tissue in order to feel for lumps and abnormalities within the breast tissue, and each of the plurality of semi-circle diagrams 111 having an arrow 112 to indicate direction.

In one embodiment of the technology described herein a breast self-examination system 010 comprises: an upper body garment 100 having a directional diagram 110 disposed upon a breast area of the upper body garment 100, the directional diagram 110 configured to aid a wearer in a breast self-examination and to aid the wearer to screen for and detect any abnormalities in a breast tissue; and a fabric marking indicator 200 for use by the wearer to indicate directly upon the garment any breast tissue changes detected, where the upper body garment 100 is knitted and is comprised of a plurality of seamless circular knitted yarns of varying deniers to provide elasticity to the wearer and to impart a selected shape of the breasts of the wearer.

In one embodiment of the technology described herein a breast self-examination system 010 comprises: an upper body garment 100 having a directional diagram 110 disposed upon a breast area of the upper body garment 100, the directional diagram 110 configured to aid a wearer in a breast self-examination and to aid the wearer to screen for and detect any abnormalities in a breast tissue; and a fabric marking indicator 200 for use by the wearer to indicate directly upon the garment any breast tissue changes detected, where the directional diagram 110 is knitted into the upper body garment 100.

In one embodiment of the technology described herein a breast self-examination system 010 comprises: an upper body garment 100 having a directional diagram 110 disposed upon a breast area of the upper body garment 100, the directional diagram 110 configured to aid a wearer in a breast self-examination and to aid the wearer to screen for and detect any abnormalities in a breast tissue; and a fabric marking indicator 200 for use by the wearer to indicate directly upon the garment any breast tissue changes detected, where the upper body garment 100 is knitted and is comprised of a plurality of seamless circular knitted yarns of varying deniers to provide elasticity to the wearer and to impart a selected shape of the breasts of the wearer, and where the plurality of semi-circle diagrams 111 is knitted into the upper body garment 100.

In one embodiment of the technology described herein a breast self-examination system 010 comprises: an upper body garment 100 having a directional diagram 110 disposed upon a breast area of the upper body garment 100, the directional diagram 110 configured to aid a wearer in a breast self-examination and to aid the wearer to screen for and detect any abnormalities in a breast tissue; a fabric marking indicator 200 for use by the wearer to indicate directly upon the garment any breast tissue changes detected, where the upper body garment 100 is comprised of a first material portion of a nylon material and a second material portion of a SPANDEX material, the nylon material configured to provide strength, lightness, and smoothness to the upper body garment 100, and the SPANDEX material configured to provide expandability to the upper body garment 100 to accommodate breast tissue; an instruction card 400; a yearly reminder calendar 300; a packaging insert 600 having a front packaging element 610 connected to a rear packaging element 620; and a container 500 for holding all the elements of the system 010, where the packaging insert is formed to be seen at the front and rear of the container. The breast self-examination system 010 is designed to facilitate and encourage regularly scheduled breast self-examinations.

In one embodiment of the technology described herein a method for manufacturing a garment for use in detecting and screening for any abnormalities in a breast tissue in a breast self-examination comprises: utilizing a knitting machine to knit a directional diagram 110 upon a breast area of an upper body garment 100; utilizing a plurality of seamless circular knitted yarns of varying deniers to provide elasticity to the wearer and to impart a selected shape of the breasts of the wearer; and configuring the directional diagram 110 to aid a wearer in a breast self-examination and aid the wearer for screening for and detecting any abnormalities in a breast tissue.

In one embodiment of the technology described herein a method for manufacturing a garment for use in detecting and screening for any abnormalities in a breast tissue in a breast self-examination comprises: utilizing a knitting machine to knit a directional diagram 110 upon a breast area of an upper body garment 100; utilizing a plurality of seamless circular knitted yarns of varying deniers to provide elasticity to the wearer and to impart a selected shape of the breasts of the wearer; and configuring the directional diagram 110 to aid a wearer in a breast self-examination and aid the wearer for screening for and detecting any abnormalities in a breast tissue; and utilizing the knitting machine to knit a plurality of semi-circle diagrams 111 along the directional diagram 110, indicative of a plurality of points where the wearer is to press deeply into a breast tissue in order to feel for lumps and abnormalities within the breast tissue, and each of the plurality of semi-circle diagrams 111 having an arrow 112 to indicate direction.

In one embodiment of the technology described herein a method for manufacturing a garment for use in detecting and screening for any abnormalities in a breast tissue in a breast self-examination comprises: utilizing a knitting machine to knit a directional diagram 110 upon a breast area of an upper body garment 100; utilizing a plurality of seamless circular knitted yarns of varying deniers to provide elasticity to the wearer and to impart a selected shape of the breasts of the wearer; configuring the directional diagram 110 to aid a wearer in a breast self-examination and aid the wearer for screening for and detecting any abnormalities in a breast tissue; utilizing a first material portion of a nylon material and a second material portion of a SPANDEX material; knitting the nylon material into the upper body garment 100 to provide strength, lightness, and smoothness; and knitting the SPANDEX material into the upper body garment 100 to provide expandability to the garment to accommodate breast tissue.

In one embodiment of the technology described herein a method for manufacturing a garment for use in detecting and screening for any abnormalities in a breast tissue in a breast self-examination comprises: utilizing a knitting machine to knit a directional diagram 110 upon a breast area of an upper body garment 100; utilizing a plurality of seamless circular knitted yarns of varying deniers to provide elasticity to the wearer and to impart a selected shape of the breasts of the wearer; and configuring the directional diagram 110 to aid a wearer in a breast self-examination and aid the wearer for screening for and detecting any abnormalities in a breast tissue, where the knitting machine is comprised of an electronic circular knitting machine with individual needle selections on a cylinder.

In one embodiment of the technology described herein a method for manufacturing a garment for use in detecting and screening for any abnormalities in a breast tissue in a breast self-examination comprises: utilizing a knitting machine to knit a directional diagram 110 upon a breast area of an upper body garment 100; utilizing a plurality of seamless circular knitted yarns of varying deniers to provide elasticity to the wearer and to impart a selected shape of the breasts of the wearer; and configuring the directional diagram 110 to aid a wearer in a breast self-examination and aid the wearer for screening for and detecting any abnormalities in a breast tissue, where the directional diagram 110 is comprised of a material dyed tonally darker than the upper body garment 100 in order to visually aid the wearer during breast self-examination.

In one embodiment of the technology described herein a method for manufacturing a garment for use in detecting and screening for any abnormalities in a breast tissue in a breast self-examination comprises: utilizing a knitting machine to knit a directional diagram 110 upon a breast area of an upper body garment 100; utilizing a plurality of seamless circular knitted yarns of varying deniers to provide elasticity to the wearer and to impart a selected shape of the breasts of the wearer; and configuring the directional diagram 110 to aid a wearer in a breast self-examination and aid the wearer for screening for and detecting any abnormalities in a breast tissue, where the breast area is comprised of a yarn of greater denier than a remainder of the upper body garment 100.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A garment for use in a breast self-examination, the garment comprising:
a directional diagram disposed upon a breast area of an upper body garment, the directional diagram configured to aid a wearer in a breast self-examination and aid the wearer to screen for and detect any abnormalities in a breast tissue.

2. The garment for use in a breast self-examination of claim 1, wherein the directional diagram is configured for use by the wearer to follow the directional diagram with a finger pressure in order to feel for lumps and abnormalities within the breast tissue.

3. The garment for use in a breast self-examination of claim 1, further comprising:
a plurality of semi-circle diagrams disposed along the directional diagram, indicative of a plurality of points where the wearer is to press deeply into a breast tissue in order to feel for lumps and abnormalities within the breast tissue, and each of the plurality of semi-circle diagrams having an arrow to indicate direction.

4. The garment for use in a breast self-examination of claim 1, wherein the garment is knitted and is comprised of a plurality of seamless circular knitted yarns of varying deniers to provide elasticity to the wearer and to impart a selected shape of the breasts of the wearer.

5. The garment for use in a breast self-examination of claim 1, wherein the directional diagram is knitted into the garment.

6. The garment for use in a breast self-examination of claim 4, wherein the plurality of semi-circle diagrams is knitted into the garment.

7. The garment for use in a breast self-examination of claim 1, wherein the garment is comprised of a first material portion of a nylon material and a second material portion of a spandex material, the nylon material configured to provide strength, lightness, and smoothness to the garment, and the spandex material configured to provide expandability to the garment to accommodate breast tissue.

8. The garment for use in a breast self-examination of claim 1, wherein the directional diagram disposed upon the breast area of the upper body garment is configured with a raised surface area, thereby configured to allow a visually impaired wearer to feel and follow the directional diagram.

9. A breast self-examination system comprising:
a upper body garment having a directional diagram disposed upon a breast area of the upper body garment, the directional diagram configured to aid a wearer in a breast self-examination and to aid the wearer to screen for and detect any abnormalities in a breast tissue; and
a fabric marking indicator for use by the wearer to indicate directly upon the garment any breast tissue changes detected.

10. The breast self-examination system of claim 9, further comprising:
a yearly reminder calendar to facilitate regularly scheduled breast self-examinations, the yearly reminder calendar having a plurality of spaces for dates and a plurality of spaces for notes by the wearer and a physician.

11. The breast self-examination system of claim 9, further comprising:
an instruction sheet with instructions on how to conduct a breast self-examination in the upper body garment for breast self-examination.

12. The breast self-examination system of claim 9, wherein the directional diagram is configured for use by the wearer to follow the directional diagram with a finger pressure in order to feel for lumps and abnormalities within a breast tissue.

13. The breast self-examination system of claim 9, further comprising:
a plurality of semi-circle diagrams disposed along the directional diagram, indicative of a plurality of points where the wearer is to press deeply into the breast tissue in order to feel for lumps and abnormalities within the breast tissue, and each of the plurality of semi-circle diagrams having an arrow to indicate direction.

14. The breast self-examination system of claim 9, wherein the upper body garment is knitted and is comprised of a plurality of seamless circular knitted yarns of varying deniers to provide elasticity to the wearer and to impart a selected shape of the breasts of the wearer.

15. The breast self-examination system of claim 9, wherein the directional diagram is knitted into the upper body garment.

16. The breast self-examination system of claim 14, wherein the plurality of semi-circle diagrams is knitted into the upper body garment.

17. The breast self-examination system of claim 9, wherein the upper body garment is comprised of a first material portion of a nylon material and a second material portion of a spandex material, the nylon material configured to provide strength, lightness, and smoothness to the upper body garment, and the spandex material configured to provide expandability to the upper body garment to accommodate breast tissue.

18. A method for manufacturing a garment for use in detecting and screening for any abnormalities in a breast tissue in a breast self-examination, the method comprising:
utilizing a knitting machine to knit a directional diagram upon a breast area of an upper body garment;
utilizing a plurality of seamless circular knitted yarns of varying deniers to provide elasticity to the wearer and to impart a selected shape of the breasts of the wearer; and
configuring the directional diagram to aid a wearer in a breast self-examination and aid the wearer for screening for and detecting any abnormalities in a breast tissue.

19. The method for manufacturing a garment for use in detecting and screening for abnormalities in a breast tissue in a breast self-examination of claim 18, further comprising:
utilizing the knitting machine to knit a plurality of semi-circle diagrams along the directional diagram, indicative of a plurality of points where the wearer is to press deeply into a breast tissue in order to feel for lumps and abnormalities within the breast tissue, and each of the plurality of semi-circle diagrams having an arrow to indicate direction.

20. The method for manufacturing a garment for use in detecting and screening for abnormalities in a breast tissue in a breast self-examination of claim 18, further comprising:
utilizing a first material portion of a nylon material and a second material portion of a spandex material;
knitting the nylon material into the upper body garment to provide strength, lightness, and smoothness; and
knitting the spandex material into the upper body garment to provide expandability to the garment to accommodate breast tissue.

21. The method for manufacturing a garment for use in detecting and screening for abnormalities in a breast tissue in a breast self-examination of claim 18, wherein the knitting machine is comprised of an electronic circular knitting machine with individual needle selections on a cylinder.

22. The method for manufacturing a garment for use in detecting and screening for abnormalities in a breast tissue in a breast self-examination of claim 18, wherein the directional diagram is comprised of a material dyed tonally darker than the upper body garment in order to visually aid the wearer during breast self-examination.

23. The method for manufacturing a garment for use in detecting and screening for abnormalities in a breast tissue in a breast self-examination of claim 18, wherein the breast area is comprised of a yarn of greater denier than a remainder of the upper body garment.
